(19) United States
(12) Patent Application Publication
(10) Pub. No.: US 2020/0230531 A1
(43) Pub. Date: Jul. 23, 2020

(54) WATER TREATMENT DEVICE

(71) Applicant: MIURA CO., LTD., Matsuyama-shi (JP)

(72) Inventors: Tomoaki TANGE, Matsuyama-shi (JP); Yasutomo ZENMAN, Matsuyama-shi (JP); Yasuhiko SAITO, Matsuyama-shi (JP)

(73) Assignee: MIURA CO., LTD., Matsuyama-shi (JP)

(21) Appl. No.: 16/687,117

(22) Filed: Nov. 18, 2019

(30) Foreign Application Priority Data
Jan. 17, 2019 (JP) 2019-006415

(51) Int. Cl. B01D 29/64; B01D 29/92; B01D 29/11; B01D 33/00

(52) U.S. Cl. CPC B01D 29/6446; B01D 33/0009; B01D 29/11; B01D 29/92

(57) ABSTRACT

The present invention provides a liquid treatment device capable of suppressing a decrease in cleaning performance. Provided is a liquid treatment device provided with a filter 2 inside a casing 1, comprising a discharge means 4, wherein the discharge means 4 comprises nozzles 41, 42 and a discharge pipe 44, the nozzles 41, 42 are arranged to open toward the filter 2, the discharge pipe 44 is arranged to discharge water introduced from the nozzles 41, 42 to an outside of the casing 1, and a first through hole 41h (42h) is formed on at least one of a side surface of the nozzles 41, 42 and the discharge pipe 44.

### TECHNICAL FIELD

The present invention relates to a water treatment device comprising a filter.

### BACKGROUND ART

A ship, such as a tanker, usually stores water referred to as ballast water in a ballast tank in order to balance the ship in operation when navigating to a destination again after unloading cargoes, such as crude oil. Such a ship is provided with a water treatment device (ballast water treatment device) for purifying the ballast water in order to prevent the destruction of the ecosystem due to the pouring and discharging of the ballast water.

As one type of the ballast water treatment device, a system that filters the ballast water by arranging a cylindrical filter in a casing (filtering device) is known. In this method, it is important to constantly clean the filter in order to prevent the filter from being blocked.

As a configuration for removing foreign material accumulated on the filter, for example, Patent Literature 1 discloses the device provided with a discharge means (suction nozzle, sludge discharge pipe, and the like) that is provided on a primary side of the filter and sucks and discharges the foreign matter, as well as the ballast water.

### CITATION LIST

### Patent Literature

### Patent Literature 1: JP-A-2004-141785

### SUMMARY OF INVENTION

### Technical Problem

In the filtration device provided with such a discharge means, when the flow rate of the liquid flowing into the discharge means increases, the nozzle arranged to open toward the filter is pressed in a direction away from the filter. Consequently, a distal end of the nozzle floats from the filter, which may reduce cleaning performance.

The present invention has been made in view of such circumstances and is aimed at providing a liquid treatment device capable of suppressing a decrease in the cleaning performance.

### Solution to Problem

According to the present invention, provided is a liquid treatment device provided with a filter inside a casing, comprising a discharge means, wherein the discharge means comprises at least one nozzle and a discharge pipe, the nozzle is arranged to open toward the filter, the discharge pipe is arranged to discharge water introduced from the nozzle to an outside of the casing, and a first through hole is formed on at least one of a side surface of the nozzle and the discharge pipe.

According to the present invention, the first through hole is provided at least one of the side surface of the nozzle and the discharge pipe, thereby reducing the flow rate of liquid flowing in from the nozzle and reducing a pressing force on the nozzle. Consequently, the distal end of the nozzle is prevented from floating from the filter, and thus it is possible to suppress the decrease in cleaning performance.

Hereinafter, various embodiments of the present invention are exemplified. The embodiments described below can be combined with each other.

Preferably, the first through hole is provided on the side surface of the nozzle.

Preferably, the nozzle comprises a pipe member, a nozzle member, and an urging means, the first through hole is provided on a side surface of the nozzle member, the pipe member is configured to connect the nozzle member with the discharge pipe, a proximal end portion of the nozzle member and a distal end portion of the pipe member are configured to fit with each other, and the urging means is configured to press the nozzle member toward the filter.

Preferably, a second through hole communicating with a primary side of the filter is formed on a side surface of the pipe member, and the first through hole and the second through hole are configured to be at least partially overlapped when the nozzle member is separated from the filter.

Preferably, the liquid treatment device comprises a rotation means, wherein the filter is formed in a cylindrical shape, and the rotation means is configured to rotate one of the filter and the discharge means with respect to the other.

Preferably, the at least one nozzle comprises a plurality of nozzles, and the rotation means is configured to rotate the filter.

### BRIEF DESCRIPTION OF DRAWINGS

FIG. 1 shows a configuration of a ballast water treatment device 10 according to a first embodiment of the present invention.

FIG. 2A is a side view showing a nozzle member 41 and a pipe member 42 included in a discharge means 4 of the ballast water treatment device 10 of FIG. 1. FIG. 2B is a plan view of the nozzle member 41 and the pipe member 42. FIG. 2C is a front view of the nozzle member 41.

FIG. 3A and FIG. 3B are explanatory views in a A-A cross section of FIG. 2C, showing a state in which the nozzle member 41 in FIG. 2B is separated from a filter 2.

FIG. 4A and FIG. 4B are plan views showing the nozzle member 41 and the pipe member 42 of the ballast water treatment device 10 according to a second embodiment of the present invention.

### DESCRIPTION OF EMBODIMENTS

### 1. First Embodiment

Hereinafter, the first embodiment of the present invention is described. Various characteristics shown in the following embodiment can be combined with each other. Further, the invention is established independently for each characteristic.

A ballast water treatment device 10 of the present embodiment is introduced in a ballast device installed in a ship in order to purify ballast water. With regard to “ballast water” in the present specification, all the water taken into the ship is referred to as “ballast water” regardless of whether the water is before being introduced into the ballast tank (not illustrated) or after being discharged from the ballast tank, or regardless of whether the water is before being introduced into (flowing into) the ballast water treatment device 10 or after being discharged from (flowing out from) the ballast water treatment device 10. In addition, the ballast water taken into the ship includes seawater, freshwater, brackish water, and the like.

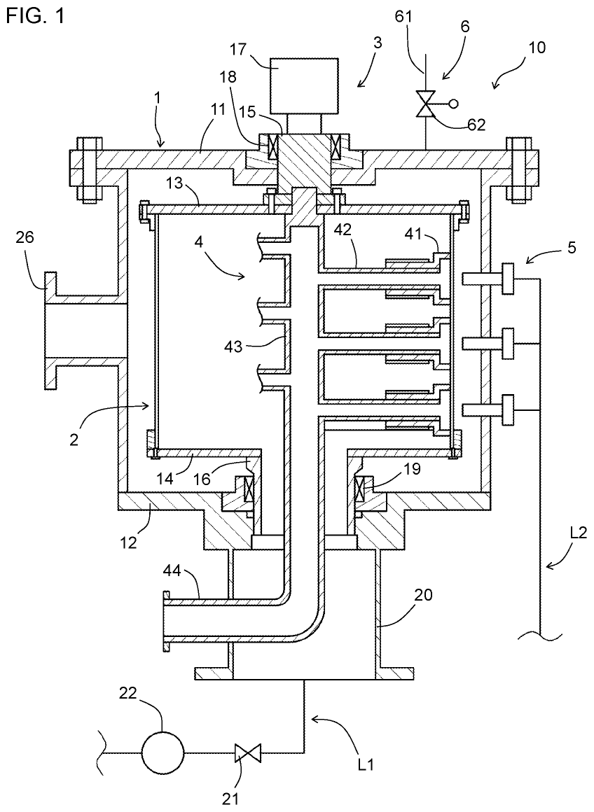

As shown in FIG. 1, the ballast water treatment device 10 as a liquid treatment device according to the first embodiment of the present invention comprises a cylindrical casing 1, a cylindrical filter 2, and a filter rotation means 3. The cylindrical filter 2 is arranged in the casing 1 and is configured to filter the unfiltered ballast water, such as sea water, that has flowed into the inside (primary side) and to allow the water to flow out to the outside (secondary side). The filter rotation means 3 rotates the filter 2 around the axis thereof.

Further, in order to clean the filter 2 during a filtration process, the ballast water treatment device 10 comprises a discharge means 4 for discharging the ballast water containing foreign material from the primary side of the filter 2, a cleaning water jet means 5 provided on the secondary side of the filter 2, for jetting the cleaning water toward the filter 2, and a compressed gas supply portion 6 for supplying compressed gas in the casing 1. In addition, an introduction line L1 for introducing the ballast water into the casing 1 and a cleaning water line L2 are connected to the ballast water treatment device 10 of the present embodiment. Each configuration is specifically described below.

The the casing 1 is formed in a cylindrical shape. An upper opening portion thereof is sealed with a lid portion 11, and a lower opening portion is sealed with a bottom portion 12. An upper opening portion of the cylindrical filter 2 arranged in the casing 1 is sealed with an upper closing portion 13, and a lower opening portion of the filter 2 is closed with a lower closing portion 14. With such configurations, the inside of the filter 2 (primary side) is separated from a space between the casing 1 and the filter 2 (secondary side). The filter 2 is formed, for example, by bending a metal plate having a large number of through holes into a cylindrical shape and welding a pair of side edges extending in a axial direction of the cylindrical shape.

The filter rotation means 3 includes an upper rotary shaft member 15, a lower rotary shaft member 16, and a motor 17. The upper rotary shaft member 15 holds the upper closing portion 13 of the filter 2, and the lower rotary shaft member 16 holds the lower closing portion 14. The motor 17 rotates the upper rotary shaft member 15. Further, the upper rotary shaft member 15 penetrates the lid portion 11 of the casing 1 and is rotatably and liquidtightly supported by the lid portion 11 via a sealed bearing member 18. The lower rotary shaft member 16 penetrates the bottom portion 12 of the casing 1 and is rotatably and liquidtightly supported by the bottom portion 12 via a sealed bearing member 19. The lower rotary shaft member 16 is a tubular body that communicates with the inside of the filter 2 and protrudes from the bottom portion 12 of the casing 1 to the outside of the casing 1, being connected to an introduction port 20 for introducing the unfiltered ballast water into the filter 2. The introduction port 20 is connected to the introduction line L1. The introduction line L1 is connected to a pump 22 of the ballast device for pumping the ballast water, with an open-close valve 21 interposed therebetween.

The casing 1 is provided, on a side thereof, with an outflow port 26 through which the filtered ballast water having passed through the filter 2 flows out. The ballast water flowing in the introduction line L1 and introduced from the introduction port 20 enters the filter 2 through the lower rotary shaft member 16, passes through the filter 2 for filtration, enters the space formed between the casing 1 and the filter 2, and then flows out from the outflow port 26. In this regard, the filtered ballast water flowing out from the outflow port 26 is stored in the ballast tank (not illustrated).

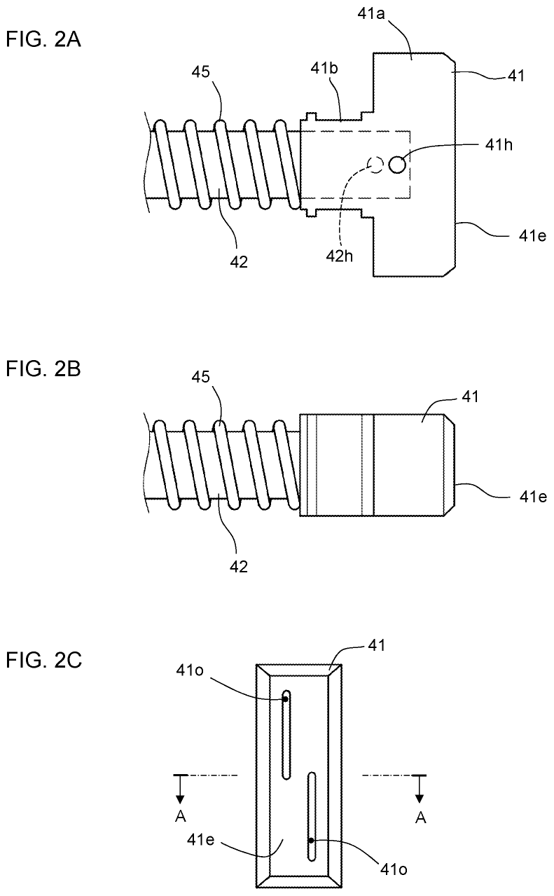

The discharge means 4 comprises a plurality of nozzle members 41, a plurality of pipe members 42, a collecting pipe 43, a discharge pipe 44, and a plurality of coil springs 45 as urging means (see FIG. 2A and FIG. 2B). In this regard, the term “nozzle” in the claims refers to each part including one nozzle member 41, one pipe member 42, and one coil spring 45 (see FIG. 2A). The discharge means 4 is used for discharging the foreign material adhering to the filter 2 to the outside of the casing 1.

The nozzle member 41 is arranged such that a distal end portion 41a thereof (see FIG. 2A) opens toward an inner peripheral surface of the filter 2 and faces the filter 2. A proximal end portion 41b of the nozzle member 41 is formed in a cylindrical shape and is connected to the pipe member 42. As shown in FIG. 2A, the distal end portion 41a of the nozzle member 41 has a larger area in a front view (that is, the area in a cross section perpendicular to a flow direction of the ballast water) than the proximal end portion 41b. As shown in FIG. 2C, the distal end portion 41a of the nozzle member 41 has a substantially rectangular shape extending in the vertical direction when viewed from the front, and two openings 41o extending in the vertical direction are formed on a distal end surface 41e in contact with the filter 2. The distal end portion 41a of the nozzle member 41 is formed in a shape extending in the vertical direction, and the opening 41o extending in the vertical direction is provided, so that the filter 2 can be cleaned over a wide area.

The pipe member 42 is a cylindrical member having a distal end connected to the nozzle member 41 and a proximal end connected to the collecting pipe 43. In the present embodiment, the nozzle members 41 and the pipe members 42 are respectively provided in a total of twelve, in four rows at 90 degree intervals in a circumferential direction and three each in the vertical direction (in FIG. 1, the members other than those extending in a right direction are omitted). Further, in order to eliminate a non-suction portion between the nozzle members 41 arranged in the vertical direction, positions in a height direction of each row are adjusted so that the nozzle members 41 in one row are positioned between the nozzle members 41 in another row.

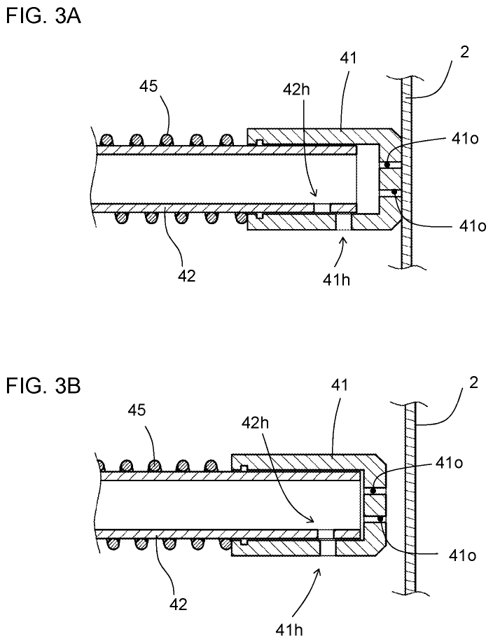

In this regard, as shown in FIG. 2A, FIG. 3A, and FIG. 3B, a first through hole 41h and a second through hole 42h are respectively formed on a side surface of the nozzle member 41 and the pipe member 42 of the present embodiment. Here, when the nozzle member 41 is in contact with the filter 2, positions of the first through hole 41h and the second through hole 42h do not coincide with each other, and the first through hole 41h is covered with the side of the pipe member 42, as shown in FIG. 3A. Therefore, when the nozzle member 41 is in contact with the filter 2, the ballast water hardly flows into the pipe member 42 via the first through hole 41h and the second through hole 42h. On the other hand, when the nozzle member 41 is separated from the filter 2, the first through hole 41h and the second through hole 42h are at least partially overlapped in a side view, as shown in FIG. 3B. The role of the first through hole 41h and the second through hole 42h in the present invention will be described later.

As shown in FIG. 1, the collecting pipe 43 is arranged inside the filter 2. More specifically, the collecting pipe 43 is arranged at a position that coincides with a central axis of the filter 2, and an upper end portion is closed, while a lower end portion is opened. The upper end portion of the collecting pipe 43 is inserted and supported in a hole provided in the center of the upper rotary shaft member 15 of the filter 2. The ballast water and the foreign material circulating in the nozzle member 41 and the pipe member 42 gather and circulate in the collecting pipe 43.

The discharge pipe 44 is connected to the lower end portion of the collecting pipe 43 and extends downward inside the lower rotary shaft member 16 so as not to prevent the rotation of the filter 2. A lower end side of the discharge pipe 44 is bent and extends to penetrate a peripheral surface of the introduction port 20. The discharge pipe 44 discharges the ballast water and the foreign material circulating in the collecting pipe 43. Further, the discharge pipe 44 of the present embodiment is provided with an adjustment valve (backwash valve, not illustrated) whose opening degree can be adjusted.

As shown in FIG. 2A and FIG. 2B, the coil spring 45 is provided on a proximal end side of the nozzle member 41, and a distal end side of the coil spring 45 comes into contact with the nozzle member 41 to press the nozzle member 41 in a direction toward the filter 2 (a right side in the drawings). A proximal end side of the coil spring 45 is fixed to the pipe member 42 or the collecting pipe 43. The coil spring 45 of the present embodiment is provided to prevent the nozzle member 41 from floating from (being separated from) the filter 2.

As shown in FIG. 1, the cleaning water jet means 5 is provided on the side of the casing 1, a distal end thereof opens in the casing 1, particularly toward an outer peripheral surface of the filter 2. The cleaning water jet means 5 is connected to the cleaning water line L2 and jets the cleaning water supplied from the cleaning water line L2 toward a surface of the secondary side of the filter 2. It is preferable that the cleaning water jet means 5 can jet the cleaning water over the entire axial direction of the filter 2, but a configuration thereof is not particularly limited. In the present embodiment, the cleaning water jet means 5 are positioned on a same circumference as the plurality of nozzle members 41 so as to face each other. In this regard, a proximal end side of the cleaning water line L2 is connected to a cleaning water supply source (not illustrated). As the cleaning water supply source, it is possible to use the ballast water processed by the filter 2. In this regard, water stored in the ballast tank, domestic water stored for another use, drinking water or the like may be used.

The compressed gas supply portion 6 comprises a compressed gas supply line 61 and a compressed gas supply valve 62, and an upstream side of the compressed gas supply line 61 is connected to a compressed gas supply source (not illustrated), such as a compressor. A downstream side of the compressed gas supply line 61 is connected to the lid portion 11 of the casing 1 and supplies the compressed gas to the space between the filter 2 and the casing 1 (a secondary side of the filter 2 inside the casing 1).

Next, the operation of the ballast water treatment device 10 of the present embodiment, particularly the operation for cleaning the filter 2 during the filtration is described.

When the ballast water flows in from the introduction port 20 through the introduction line L1 by being driven by the pump 22, the ballast water flows into the filter 2 and passes through the filter 2 for filtration. At this time, the filter rotation means 3 rotates the filter 2. Consequently, the filter 2 is rotated with respect to the discharge means 4. The ballast water then enters the space formed between the casing 1 and the filter 2 and flows out from the outflow port 26. The ballast water that has flowed out is stored in the ballast tank (not illustrated) through an outflow water channel.

The cleaning operation during the filtration of the ballast water is performed continuously or intermittently. Specifically, since pressure in the discharge means 4 is lower than secondary pressure of the filter 2, by opening the adjustment valve installed in the discharge pipe 44, the foreign material adhering to the filter 2 is sucked from the opening 41o of the nozzle member 41 together with the filtered ballast water on the secondary side of the filter 2 and is discharged to the outside through the pipe member 42, the collecting pipe 43, and the discharge pipe 44.

Further, at the time of cleaning during the filtration, the cleaning water jet means 5 jets the cleaning water toward the filter 2. Consequently, the foreign material adhering to the filter 2 is peeled off from the filter 2 and effectively removed from the nozzle member 41.

In this regard, the cleaning water jet means 5 is also used when the operation of the ballast water treatment device 10 is completed or when the filter 2 needs to be powerfully cleaned. In such cleaning, the ballast water in the casing 1 can be quickly discharged by opening the compressed gas supply valve 62 of the compressed gas supply portion 6.

In the prior art, the nozzle arranged to open toward the filter is pressed in a direction away from the filter when the flow rate of liquid flowing into the discharge means increases. Consequently, the distal end of the nozzle floats from the filter, which may reduce the cleaning performance.

In the ballast water treatment device 10 of the present embodiment, the first through hole 41h and the second through hole 42h are respectively provided on a side surface of the nozzle member 41 and the pipe member 42. In addition, the positions of the holes are designed so that the first through hole 41h and the second through hole 42h are gradually overlapped (see FIG. 3A and FIG. 3B) when the distal end of nozzle member 41 is separated from the filter 2. With such a configuration, as the nozzle member 41 is separated from the filter 2, the overlapping area of the first through hole 41h and the second through hole 42h increases. Consequently, as the nozzle member 41 is separated from the filter 2, the flow rate of the ballast water flowing into the discharge means 4 through the first through hole 41h and the second through hole 42h increases. Since the flow rate of the ballast water flowing from the opening 41o into the nozzle member 41 decreases, it is possible to suppress the nozzle member 41 from being pressed and separated from the filter 2. In this regard, when the distal end of the nozzle member 41 is in contact with the filter 2, the first through hole 41h and the second through hole 42h are not overlapped. Therefore, the ballast water hardly flows into the discharge means 4 through the first through hole 41h and the second through hole 42h, and the cleaning performance of the nozzle member 41 can be thus ensured.

In the ballast water treatment device 10 of the present embodiment, the first through hole 41h is formed in the nozzle member 41, so that the ballast water always flows into the nozzle member 41 through the first through hole 41h. Therefore, it is possible to suppress fluctuations in the flow rate of the ballast water in the discharge means 4, for example, even when the cylindrical filter has a seam or when the degree of adhesion of the foreign material to the filter varies.

The present invention can be implemented also in the following aspects.

In the first embodiment described above, the first through hole 41h of the nozzle member 41 and the second through hole 42h of the pipe member 42 are formed respectively on the side surface of the nozzle member 41 and the pipe member 42. As long as the positions of the first through hole 41h and the second through hole 42h are matched, each through hole can be provided at any position.

In the embodiment described above, the first through hole 41h and the second through hole 42h have a circular shape. The through hole can be formed in any shape, for example, in a polygonal shape, such as a rectangle.

### 2. Second Embodiment

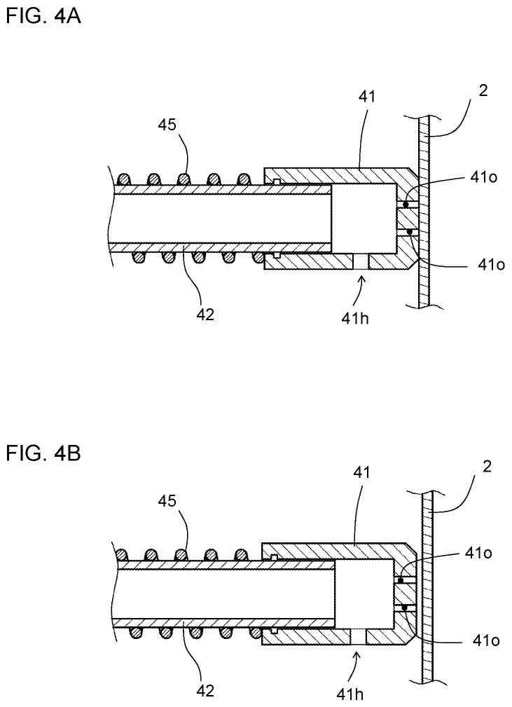

Next, the ballast water treatment device 10 according to the second embodiment of the present invention is described. As shown in FIG. 4A and FIG. 4B, the ballast water treatment device 10 of the second embodiment is different only in the shape of the discharge means 4, specifically in the shape of the nozzle member 41 and the pipe member 42. Therefore, only the difference is described below.

In the discharge means 4 of the present embodiment, as shown in FIG. 4A, the first through hole 41h is formed on the side surface of the nozzle member 41, as in the first embodiment, while no hole is formed on the pipe member 42. Here, the pipe member 42 is shorter than that of the first embodiment, and the discharge means 4 is configured so that the ballast water flows into the discharge means 4 regardless of the movement of the nozzle member 41 (see FIG. 4B).

Even with such a configuration, the impact of water can be suppressed because the fluctuation in the circulation amount of the ballast water in the discharge means 4 is suppressed.

The present invention can be implemented also in the following aspects.

Although the ballast water treatment device 10 in the embodiment described above is configured such that the filter 2 is rotated with respect to the nozzle member 41, the configuration of the device is not limited thereto. That is, the present invention may be applied to a ballast water treatment device in which the discharge means 4 (the nozzle member 41) is configured to be rotated with respect to the fixed filter 2. In addition, the present invention may be also applied to a ballast water treatment device in which neither the nozzle member nor the filter is rotated.

Although the filter 2 in the embodiment described above is arranged so that the rotary shaft of the filter 2 is along the vertical direction, the arrangement of the filter 2 is not limited thereto. That is, the filter may be arranged so that the rotary shaft thereof is along the horizontal direction.

While the discharge means 4 is arranged inside the filter 2 in the embodiment described above, the discharge means 4 may be arranged outside the filter 2. That is, the discharge means 4 may be arranged on the primary side of the filter 2 or on the secondary side of the filter 2.

While the ballast water is circulated so that the inside of the filter 2 is the primary side and the outside of the filter 2 is the secondary side in the embodiment described above, it is also possible to circulate the ballast water so that the outside of the filter 2 is the primary side, and the inside is the secondary side.

Although the present invention is applied, in the embodiment described above, to the ballast water treatment device used in a ship for processing the ballast water, the application of the invention is not limited thereto. That is, the present invention may be applied to a water treatment device for processing, for example, water of seas, rivers, lakes, and ponds, and industrial water. In addition, the invention may be applied not to a water treatment device for processing water but to a liquid treatment device for processing liquid other than water (for example, oil).

While the nozzle member 41 and the pipe member 42 of the discharge means 4 are configured as separate members in the embodiment described above, the nozzle member 41 and the pipe member 42 may be integrally formed. It is possible, also in this case, to suppress the flow rate and the impact of the ballast water flowing in from the opening 41o by providing the through hole in the nozzle member 41 formed integrally.

The first through hole 41h is formed on the side surface of the nozzle member 41 in the embodiment described above but may be formed at any position as long as the ballast water can be circulated therein, for example, on an upper surface and a lower surface. In addition, the first through hole 41h may be formed on the pipe member 42, the collecting pipe 43, or the discharge pipe 44. Even when the first through hole 41h is formed in such a position, it is possible to suppress the fluctuation in the flow rate and the impact of the ballast water in the discharge means 4 because the ballast water always flows into the discharge means 4.

### REFERENCE SIGN LIST

1: Casing
2: Filter
3: Filter rotation means
4: Discharge means
5: Cleaning water jet means
6: Compressed gas supply portion
10: Ballast water treatment device (liquid treatment device)
11: Lid portion
12: Bottom portion
13: Upper closing portion
14: Lower closing portion
15: Upper rotary shaft member
16: Lower rotary shaft member
17: Motor
18: Bearing member
19: Bearing member
20: Introduction port
21: Open-close valve
22: Pump
26: Outflow port
41: Nozzle member (nozzle)
41a: Distal end portion
41b: Proximal end portion
41e: Distal end surface
41h: First through hole
41o: Opening
42: Pipe member (pipe)
42h: Second through hole
43: Collecting pipe
44: Discharge pipe
45: Coil spring (urging means)
61: Compressed gas supply line
62: Compressed gas supply valve
L1: Introduction line
L2: Cleaning water line

1. A liquid treatment device provided with a filter inside a casing,
comprising a discharge means,
wherein the discharge means comprises at least one nozzle and a discharge pipe,
the nozzle is arranged to open toward the filter,
the discharge pipe is arranged to discharge water introduced from the nozzle to an outside of the casing, and
a first through hole is formed on at least one of a side surface of the nozzle and the discharge pipe.

2. The liquid treatment device of claim 1,
wherein the first through hole is provided on the side surface of the nozzle.

3. The liquid treatment device of claim 2,
wherein the nozzle comprises a pipe member, a nozzle member, and an urging means,
the first through hole is provided on a side surface of the nozzle member,
the pipe member is configured to connect the nozzle member with the discharge pipe,
a proximal end portion of the nozzle member and a distal end portion of the pipe member are configured to fit with each other, and
the urging means is configured to press the nozzle member toward the filter.

4. The liquid treatment device of claim 3,
wherein a second through hole communicating with a primary side of the filter is formed on a side surface of the pipe member, and
the first through hole and the second through hole are configured to be at least partially overlapped when the nozzle member is separated from the filter.

5. The liquid treatment device of any one of claim 1,
comprising a rotation means,
wherein the filter is formed in a cylindrical shape, and
the rotation means is configured to rotate one of the filter and the discharge means with respect to the other.

6. The liquid treatment device of claim 5,
wherein the at least one nozzle comprises a plurality of nozzles, and
the rotation means is configured to rotate the filter.
